(19) United States
(12) Patent Application Publication
(10) Pub. No.: US 2025/0124435 A1
(43) Pub. Date: Apr. 17, 2025

(54) SYSTEMS AND METHODS FOR GENERATING TOKENS FOR TRACKING ITEMS USING A BLOCKCHAIN

(71) Applicant: MASTERCARD INTERNATIONAL INCORPORATED, Purchase, NY (US)

(72) Inventors: Ragunath Venkatapathy, O'Fallon, MO (US); Prasanna Srinivasan Narasimhan, O'Fallon, MO (US); Ramya Kumarasamy, O'Fallon, MO (US)

(21) Appl. No.: 18/487,930

(22) Filed: Oct. 16, 2023

(51) Int. Cl. G06Q 20/40; G06Q 20/02; G06Q 20/38

(52) U.S. Cl. CPC G06Q 20/4014; G06Q 20/02; G06Q 20/389

(57) ABSTRACT

A computer system is provided. The computer system may capture transaction data from a transaction message, the transaction data identifying (i) a user, (ii) at least one item, and (iii) at least one transaction value; determine that the at least one item is a re-sellable item; generate a token associated with the at least one item, the token including (i) a user identifier associated with the user, (ii) an item identifier associated with the at least one item, and (iii) an item value associated with the at least one item; record the generated token in a blockchain; parse the blockchain to identify tokens including the user identifier; and generate user interface data configured to cause the user device to display a user interface, wherein the user interface includes the at least one item and the item value associated with the at least one item.

### BACKGROUND

The present disclosure relates to distributed ledger or “blockchain” ecosystems, and more particularly to a blockchain ecosystem for tracking items using generated tokens.

Individuals may own items that may be recycled or sold to other individuals. However, in some cases, it is often difficult for individuals to keep track of all the different items the individual has obtained and to determine whether items are capable of being recycled or resold. Computers generally are not capable of tracking physical items without manual data entry, which itself may be a difficult and time-consuming process and typically requires that the individual take extra steps when obtaining or disposing of the items. Due to this inability to track physical items, any potential value associated with recyclable or re-sellable items may be left unrealized. A computer system capable of tracking such physical items is needed so that these items can more easily be recycled or resold to another user.

### BRIEF DESCRIPTION OF THE DISCLOSURE

In one aspect, a computer system is provided. The computer system may include at least one processor in communication with at least one memory. The at least one processor may be configured to capture transaction data from a transaction message, the transaction data identifying (i) a user, (ii) at least one item, and (iii) at least one transaction value. The at least one processor may be further configured to determine that the at least one item is a re-sellable item. The at least one processor may be further configured to, in response to determining that the at least one item is a re-sellable item, generate a token associated with the at least one item, the token including (i) a user identifier associated with the user, (ii) an item identifier associated with the at least one item, and (iii) an item value associated with the at least one item. The at least one processor may be further configured to record the generated token in a blockchain. The at least one processor may be further configured to, in response to receiving a request from a user device associated with the user, parse the blockchain to identify tokens including the user identifier, wherein the identified tokens include the generated token. The at least one processor may be further configured to generate user interface data configured to cause the user device to display a user interface, wherein the user interface includes data extracted from the identified tokens including the at least one item and the item value associated with the at least one item.

In another aspect, a computer-implemented method is provided. The computer-implemented method may be performed by a computer system including at least one processor in communication with at least one memory. The computer-implemented method may include capturing transaction data from a transaction message, the transaction data identifying (i) a user, (ii) at least one item, and (iii) at least one transaction value. The computer-implemented method may further include determining that the at least one item is a re-sellable item. The computer-implemented method may further include, in response to determining that the at least one item is a re-sellable item, generating a token associated with the at least one item, the token including (i) a user identifier associated with the user, (ii) an item identifier associated with the at least one item, and (iii) an item value associated with the at least one item. The computer-implemented method may further include recording the generated token in a blockchain. The computer-implemented method may further include, in response to receiving a request from a user device associated with the user, parsing the blockchain to identify tokens including the user identifier, wherein the identified tokens include the generated token. The computer-implemented method may further include generating user interface data configured to cause the user device to display a user interface, wherein the user interface includes data extracted from the identified tokens including the at least one item and the item value associated with the at least one item.

In another aspect, at least one non-transitory computer-readable storage media having computer-executable instructions embodied thereon is provided. When executed by a computer system including at least one processor in communication with at least one memory, the computer-executable instructions cause at least one processor configured to capture transaction data from a transaction message, the transaction data identifying (i) a user, (ii) at least one item, and (iii) at least one transaction value. The computer-executable instructions may further cause the at least one processor to determine that the at least one item is a re-sellable item. The computer-executable instructions may further cause the at least one processor to in response to determining that the at least one item is a re-sellable item, generate a token associated with the at least one item, the token including (i) a user identifier associated with the user, (ii) an item identifier associated with the at least one item, and (iii) an item value associated with the at least one item. The computer-executable instructions may further cause the at least one processor to record the generated token in a blockchain. The computer-executable instructions may further cause the at least one processor to, in response to receiving a request from a user device associated with the user, parse the blockchain to identify tokens including the user identifier, wherein the identified tokens include the generated token. The computer-executable instructions may further cause the at least one processor to generate user interface data configured to cause the user device to display a user interface, wherein the user interface includes data extracted from the identified tokens including the at least one item and the item value associated with the at least one item.

### BRIEF DESCRIPTION OF THE DRAWINGS

FIGS. 1-9 show example embodiments of the systems and methods described herein.

FIG. 1 is a schematic diagram illustrating an example multi-party payment card processing system for enabling payment-by-card transactions.

FIG. 2 is a simplified block diagram of an example system used for recording and tracking tokens corresponding to items in a distributed ledger, in accordance with one embodiment of the present disclosure.

FIG. 3 illustrates an example configuration of a client system shown in FIG. 2, in accordance with an embodiment of the present disclosure.

FIG. 4 illustrates an example configuration of the server system shown in FIG. 2, in accordance with an embodiment of the present disclosure.

FIG. 5 is a flow diagram illustrating an exemplary method for tracking items using a distributed ledger, in accordance with one embodiment of the present disclosure.

FIG. 6 is a flow diagram illustrating an exemplary method for updating an item value in a distributed ledger, in accordance with one embodiment of the present disclosure.

FIG. 7 is a flow diagram illustrating an exemplary method for using a token to track a transfer of an item via a virtual marketplace, in accordance with one embodiment of the present disclosure.

FIG. 8 is a flow diagram illustrating an exemplary method for tracking an item transferred to a third party using a distributed ledger, in accordance with one embodiment of the present disclosure.

FIG. 9 is a chart illustrating an exemplary sequence of modifications of a token associated with an item, in accordance with one embodiment of the present disclosure.

The following detailed description and exemplary embodiments are intended for illustration purposes only and are, therefore, not intended to limit the scope of the disclosure.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to example embodiments, namely, methods and systems utilizing a distributed ledger, or “blockchain,” for recording and tracking tokens corresponding to items.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, a “processor” may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term processor.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In some embodiments, a computer program is provided, and the program is embodied on a computer readable medium. In an exemplary embodiment, the program is executed on a single computer system, without requiring a connection to a sever computer. In at least one embodiment, the program is run in a Windows® environment (Windows is a registered trademark of Microsoft Corporation, Redmond, Washington). In another embodiment, the program is run on a mainframe environment and a UNIX® server environment (UNIX is a registered trademark of X/Open Company Limited located in Reading, Berkshire, United Kingdom). In these examples, the program is flexible and designed to run in various different environments without compromising any major functionality. In some embodiments, a system includes multiple components distributed among a plurality of computing devices. One or more components may be in the form of computer-executable instructions embodied in a computer-readable medium. The systems, processes, and programs are not limited to the specific embodiments described herein. In some embodiments, system or process components can be practiced independently and separately from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, wearables, smartphones, personal digital assistants (PDAs), key fobs, and/or any other computing devices capable of storing and providing account data. Each type of transaction card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

As used herein, the term “payment network” refers to a system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, crypto-currency (e.g., Bitcoin) etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

As used herein, the term “distributed ledger” refers to a public ledger of all transactions performed between parties having access to the distributed ledger. The distributed ledger may be blockchain-based, or a similar system that creates a decentralized immutable ledger of cryptographically added blocks to append to existing transactions. Within this disclosure, “distributed ledger” and “blockchain” may be used interchangeably, but a person of ordinary skill in the art will understand that the distributed ledger embodiments described herein are not limited solely to conventional blockchain technologies.

Where the distributed ledger utilizes blockchain technology specifically, transaction information is encapsulated in a digital envelope or “block” and then the block is cryptographically added (using cipher chaining techniques) to the end of a chain of other transactions. This cryptographic addition incorporates information from prior blocks on the chain to calculate the digital chain or “hash” for this new block. The calculations for cryptographic addition can vary widely in complexity based on the rules of the blockchain. This complexity is purposeful though, in order to prevent modification of the existing blockchain to which is being added. That is, in order to modify an earlier block in the chain, the entire chain from that point forward would need to be recalculated. It is through this technique that the immutability of the chain, and permanency of its public ledger, is maintained. One or more computing devices may be included in a computer system that utilizes the distributed ledger, and which may be configured to process and record transactions as separate blocks in a chain. In some instances, the chain may represent a ledger of transactions in chronological order, or may be presented in another organized structure that may be suitable for use by the computer system. The computer system may be a public network, or a trusted private network.

The computer network described herein is part of an ecosystem that includes consumers, merchants, point-of-sale (POS) application or POS device manufacturers, and/or financial institutions, as well as other interested entities that may subscribe to related services. Ecosystem participants typically desire privacy, and thus, in most embodiments, all data shared across the network is considered to be anonymized, pseudo-anonymous, aggregated, and/or otherwise masked to meet participant requirements, and also to conform with all local, state, national, and international privacy/data usage laws relevant to the network.

As used herein, the term “consumer” refers to a cardholder of the payment network. In the embodiments described herein, each payment card utilized with the payment network is treated as a separate identity, and card-level data is not shared with the computer network. In some embodiments, financial institution identifying information may be shared across the network.

As used herein, the term “merchant” refers to an identifier of a legal business entity, as well as a location of the legal entity, where applicable. In some embodiments, a one-to-one mapping may be had between the location and the entity itself, whereas in other embodiments, a location (e.g., a geocoded address) may not be available.

As used herein, the term “financial institution” refers to a network participant capable of processing and analyzing financial transaction information for transactions blocks submitted to the network. In some embodiments, the financial Institution is assigned a Globally Unique Identifier (GUID) based on its particular legal entity information.

In an exemplary embodiment, a computer system may capture transaction data from a transaction message. The transaction data may identify (i) a user, (ii) at least one item, and (iii) at least one transaction value. For example, the transaction message may be a payment card transaction request message (e.g., authorization request or response message) submitted over a payment interchange network (e.g., ISO 8583 or ISO 20022 messages), which may include an account number (Primary Account Number (PAN)) that identifies or is associated with a user (e.g., a consumer or legitimate cardholder) and an amount associated with the purchase transaction. The transaction message may further include information capable of identifying one or more items involved in the transaction, such as a stock keeping unit (SKU) identifier, serial number, product name or description, or other information that may be used to identify the at least one item. By identifying the at least one item, the computer system may determine if the at least one item is capable of being resold and/or recycled, and if so, track the item as described in further detail below. In some embodiments, additional data, such as a merchant associated with the transaction, a location of the transaction, or other such information may be captured from the transaction message and retained by the computer system.

As discussed herein, the transaction messages may include authorization messages and/or clearing messages that may be in an ISO 8583 or ISO 20022 message format for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In the exemplary embodiment, the computer system may determine that the at least one item is a re-sellable item and/or a recyclable item based on one or more predefined rules stored within a memory at the payment processing system or by applying machine learning and/or artificial intelligence (ML/AI) techniques to the transaction data. For example, the computer system may compare and/or cross-references the at least one item with a list or database of items deemed to be re-sellable and/or recyclable. In some embodiments, the computer system may use a machine learning and/or artificial intelligence (AI) model to determine whether an item is re-sellable or recyclable. The machine learning and/or artificial intelligence model may be trained using training data that includes exemplary items and labels indicating whether the exemplary items are re-sellable and/or recyclable. The machine learning model and/or artificial intelligence model, once trained, may be capable of predicting whether an input item is re-sellable and/or recyclable based on characteristics of the input item. Alternatively, other supervised or unsupervised machine learning techniques may be used to train such a model. In some embodiments, additional factors, such as whether the item is deemed to include potentially hazardous materials, a location of the item and local laws or regulations relating to the item, or other such factors may be used to determine whether an item can be resold or recycled. In addition, after the model is trained, the model can later be re-trained using actual input data that is used by the model to generate an output regarding whether the item at issue is re-sellable and/or recyclable, along with whether the item is actually later re-sold or at least acknowledged by the purchaser as being an item that is capable of being re-sold or recycled.

In some embodiments, the system may include a dedicated module, such as a rules engine and/or an AI model, configured to determine, when a purchase is made, whether the purchased item is recyclable and/or re-sellable. Based on whether the item is recyclable and/or re-sellable, a different type of token may be generated by the system at the time of purchase such that the token may indicate whether the purchased item is re-sellable and/or recyclable. For example, if the item is re-sellable, the token may be generated according to a first format that indicates the item is re-sellable; and if the item is recyclable, the token may be generated according to a second format (different from the first format) that enables the item to be tracked through the recycling process. In some embodiments, if server system is not capable of determining whether an item is recyclable and/or re-sellable with a sufficient confidence, it may prompt and/or message the purchasing user (e.g., at a user device via a user interface) to input whether the item is recyclable and/or re-sellable, if known.

Examples of items that are considered re-sellable or recyclable may include, among others, durable goods, appliances, vehicles, building materials, furniture, electronics, office equipment, clothing, artwork and jewelry, media such as books, music, films, and/or games, containers and/or bottles, and/or items made from recyclable materials such as metal or plastic. Items that are not considered re-sellable or recyclable may include, among others, food, beverages, soap, chemical products, and/or other items that are unable to be reused after some amount of use.

In the exemplary embodiment, in response to determining that the at least one item is a re-sellable item, the computer system may automatically generate a token associated with the at least one item. The token may be a predefined data structure that may include at least one unique data element to distinguish the token from other tokens. The token may further include (i) a user identifier associated with the user, (ii) an item identifier associated with the at least one item and capable of identifying the item; and (iii) an item value associated with the at least one item. The item identifier may be unique to a specific item and/or class of similar items. The item identifier may be, for example, an SKU identifier, a serial number, and/or an alphanumeric code that has a predefined association with the item, where it was manufactured, when it was manufactured, and where and when it was sold. The item value may be determined based on the transaction data (e.g., the item value may be price and/or transaction amount associated with the transaction) and/or may be determined based on additional data. For example, in some embodiments, one or more third party databases may be queried by the computer system to determine an item value, or machine learning and/or artificial intelligence techniques may be used to determine the item value.

In the exemplary embodiment, the computer system may record, store, and/or track the generated token in a blockchain. For example, a new node of the blockchain may be generated, which may include the token and/or information referring to the token. The token and/or node may include a hashed identifier, which may be signed by the key of one or more participants of the transaction. In one example, SHA-256 hashing is utilized, which may additionally include Elliptic Curve Digital Signature Algorithm (ECDSA), where appropriate. In the exemplary embodiment, the computer system is configured to securely store assigned GUIDS and Key relationships in the back-end.

These security features associated with blockchain ledgers enable the token and information included in the token to be verified by other users, such as those potentially interested in purchasing the item through resale. Accordingly, aspects of the item, such as the item value, the manufacturer or brand (e.g., to ensure the item is not counterfeit), physical characteristics of the item (e.g., to ensure the item matches a description provided by the seller, an age of the item, previous owners of the item, a current or previous location of the item, and/or other such information. For example, if a token corresponds to a piece of jewelry, the token and/or associated blockchain records may include a brand, an original sale or any previous resale values, and physical characteristics of the jewelry such as a material, carat value, or the like. In another example, the token may correspond to an item to be recycled, such as copper plumbing, and a recycling entity may use previous transaction history included in the records to ensure that the copper plumbing was obtained legitimately. Because this information is automatically generated in response to a payment transaction and not readily modifiable, the token is, in itself, capable of verifying ownership and a value of an item.

In the exemplary embodiment, in response to receiving a request from a user device associated with the user, the computer system may parse the blockchain to identify tokens including the user identifier. For example, the user may desire to view which items the user currently owns that may be resold and/or recycled, and/or may wish to determine whether a specific item is re-sellable and/or recyclable, and may input the request via the user device via a user interface (e.g., displayed by a web page or other application executing on the user device).

In the exemplary embodiment, the computer system may generate user interface data configured to cause the user device to display the user interface. The user interface may include data extracted from the identified tokens, such as the items associated with the identified tokens and the item values associated with the items. Accordingly, the user interface may enable the user to view each of the user's currently-owned re-sellable and/or recyclable items and their corresponding values. In some embodiments, the user interface may present the items as a list, with the list including each item and its corresponding value. In some embodiments, the list may be searchable and/or filterable. For example, the user may input a keyword search terms, based on which items matching the search terms may be displayed. In another example, the user interface may enable the list to be filtered based on certain parameters, such as item type, item value, date purchased, and/or other such factors. In some embodiments, the user interface may include chatbot functionality. For example, a user may input a natural language query (e.g., text or speech), and the computer system may utilize one or more chatbots to generate search results within the user interface.

In some embodiments, the computer system may receive an update message from the user device. The update message may include an updated item value associated with at least one item. For example, the user may desire to update the value of the item so that the user may resell the item at an appropriate value. The user may input a new value (e.g., a desired resale price) via the user interface, and in response, the user device may generate the update message and transmit the update message to the computer system. In response to receiving the update message, computer system may modify the token or generate another token relating to the item. The modified or new token may include the updated item value, as well as the current user identifier and item identifier associated with the item. The modification to the token or the new token may be recorded in the blockchain, so that subsequent searches and retrievals based the item identifier associated with the specified item will cause the updated item value to be presented. The user may update an item value multiple times in this manner. In some embodiments, the item value may be periodically updated automatically, for example, based on third party information (e.g., retrieved from the Internet and/or third party databases). For example, if the item includes a commodity such as wood, and a price of wood increases, the computer system may automatically calculate an updated item value and generate a new token to update the item value associated with the item in the blockchain.

In some embodiments, the computer system may receive a resale request message from the user device, which enables the user to list an item for sale in a virtual marketplace. For example, the user may input via the user interface that the user desires to resell a certain item. In some embodiments, this user input may include a “drag and drop” operation, in which the user touches or clicks on the item and drags the item to a “marketplace” portion of the user interface. The resale request message may include the item identifier associated with the item that the user desires to resell. In response to receiving the resale request message, the information stored in the blockchain for the item may become publicly viewable such that the blockchain enables discovery of the token in the blockchain by at least one other computing device (referred to as a “buyer computing device”). In other words, if other users of the system search the blockchain, the listed item may be retrieved and displayed on a respective user interface (referred to as a “buyer interface”) of the buyer computing device, along with other information such as the item value currently associated with the item and/or information relating to the user who currently owns the item (e.g., a user name, location, etc.). In some embodiments, the value of the item may be automatically updated by the system when the system crawls the Internet to search for similar items and the prices of those items in order to determine the current value of the item. The system then updates the value of the item in the blockchain so that the value of the item is always up-to-date. In some embodiments, the buyer interface displayed by the buyer computing device may enable searching for items and displaying search results. For example, the potential buyer may input a keyword search terms, based on which items matching the search terms may be displayed. The buyer interface may enable the list to be filtered based on certain parameters, such as item type, item value, date purchased, and/or other such factors. In some embodiments, the buyer interface may include chatbot functionality. For example, a user may input a natural language query (e.g., text or speech), and the computer system may utilize one or more chatbots to generate search results within the user interface.

In some embodiments, the computer system may receive a purchase request message from the buyer computing device associated with the buyer. For example, the purchase request message may be generated and transmitted by the buyer computing device in response to input from the buyer indicating that the buyer wishes to purchase the item. In some embodiments, the buyer must submit payment information via the buyer interface, such payment card information, in order to request to purchase the item. In response to receiving the purchase request message, the computer system may modify the token to include, or generate a new token including, a second user identifier associated with the buyer. The modified or new token may also include the item identifier and current item value associated with the at least one item. The modification or new token may be recorded in the blockchain, such that the item will now be associated with the buyer upon subsequent searching and/or parsing of the blockchain. In some embodiments, the computer system may track sales and/or transfers of ownership of the item that occur outside of the virtual marketplace, such as based on transaction data as described above.

In some embodiments, the item may include a tag, which may enable the item to be tracked through transfers of possession and/or ownership that occur outside the marketplace provided by the computer system. For example, a user may deposit an item to be recycled, and possession of the item may be taken over by a recycling entity. The tag may include a visible indicator such as an alphanumeric code, a quick response (QR) code, or a bar code, or another type of tag such as a radio frequency (RF) near field communication (NFC) tag, which may be scanned and/or input by the entity receiving the item. The tag may include the item identifier, enabling the item to be identified, and in some embodiments, associated with the previous owner of the item. In response to scanning and/or receiving input of the tag, a third party computing device may generate and transmit a tag message including the item identifier and/or any other information included in the tag. The computing system may receive the tag message from a third party computing device, and cause the user computing device to display a notification that the at least one item has been received by the third party. The computer system may further generate a new token and/or otherwise update the blockchain to indicate that the item is now owned by a new entity.

In embodiments in which the item is recycled, the user may view the notifications indicating that the item has been received by a recycling entity and/or recycled. In some embodiments, the computer system may compile statistics for the user, such as a total amount of items recycled and/or a total value recycled, which may be viewed via the user interface. In some embodiments, the computer system may retrieve information about what new products materials from the recycled items were used to make, and cause this information to be displayed via the user interface. Receiving notifications and/or being able to track what happens to recycled items may incentivize the user to recycle more often. In some embodiments, the computer system may determine, based information about what the user has recycled, that the user is eligible for a reward, such as a cash reward and/or a coupon, which may incentivize the user to recycle. In addition, the system's ability to track recycled items for a plurality of people in a predefined geographic location allows the system to track how a neighborhood, a community, a town and/or a city is doing with its recycling efforts. In fact, the system can determine when items are being recycled and by who, and using GPS technology can determine where those items are being recycled, and thus, can generate a dashboard for display on a user device to see how many items are being recycled and/or how much of a positive impact certain recycling efforts are having on the environment.

In some cases, items may be destroyed, and/or may be merged or divided to create new items. In such cases, tokens corresponding to the items may be modified or supplanted in the blockchain to indicate that the item associated with the token no longer exists, and new tokens may be generated and stored in the blockchain representing the new items created by merging or dividing previous items.

Because the system may capture data from an ISO compliant message transmitted over a transaction network such as a payment interchange network, as the item is being purchased, the system may automatically determine, in real time without any additional user input, whether the item is recyclable and/or re-sellable, and may then automatically generate a token in response. The token may have security features build into the token that prevent the token from being altered or reproduced outside the protocols of the system. The automatically-generated token may include information such as where the item was purchased, who purchased the item, the payment value associated with the purchase, where the purchase occurred, and other such information. This information may be incorporated into the secure token and recorded in the distributed ledger, enabling this information, such as who currently owns the product, the current value associated with the product, and information relating to characteristics of the item to be verified by others (e.g., others who may potentially purchase the items in a resale). By utilizing real time transaction data, the system enables these secure records to be generated in the ledger in real time at the moment of purchase.

At least one technical problem with known systems is that computer systems cannot automatically, and securely, track physical items and their respective values without manual data entry. The computer system described herein provides technical solutions including at least one of: (a) enabling a computer system to track an item and its value by generating a token corresponding to an item in response to receiving transaction data and recording the token in a blockchain; (b) enabling a computer system to track a change in a value of an item by modifying a token corresponding to the item and recording the modification to the token in a blockchain; (c) enabling a computer system to track a change in a ownership of an item by modifying a token corresponding to the item and recording the modification to the token in a blockchain; and/or (d) enabling a computer system to track a change in a value of an item by receiving an indication that a tag located on the item has been scanned or entered and, in response, modifying a token corresponding to the item and recording the modification to the token in a blockchain.

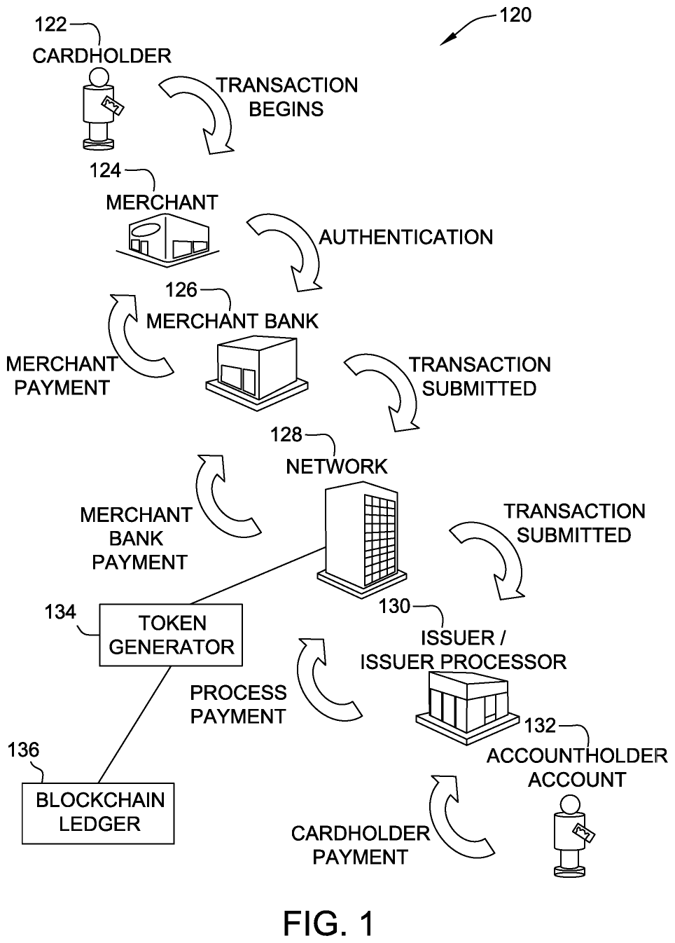

FIG. 1 is a schematic diagram illustrating an example payment network 120 for enabling payment-by-card transactions between merchants 124, card issuers 130, and cardholders 122. Embodiments described herein may relate to a transaction card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, New York).

In a typical transaction card system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads account information of cardholder 122 from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether account 132 of cardholder 122 is in good standing and whether the purchase is covered by cardholder's 122 available credit line. Based on these determinations, the request for authorization will be declined or accepted. If the request is accepted, an authorization code is issued to merchant 124.

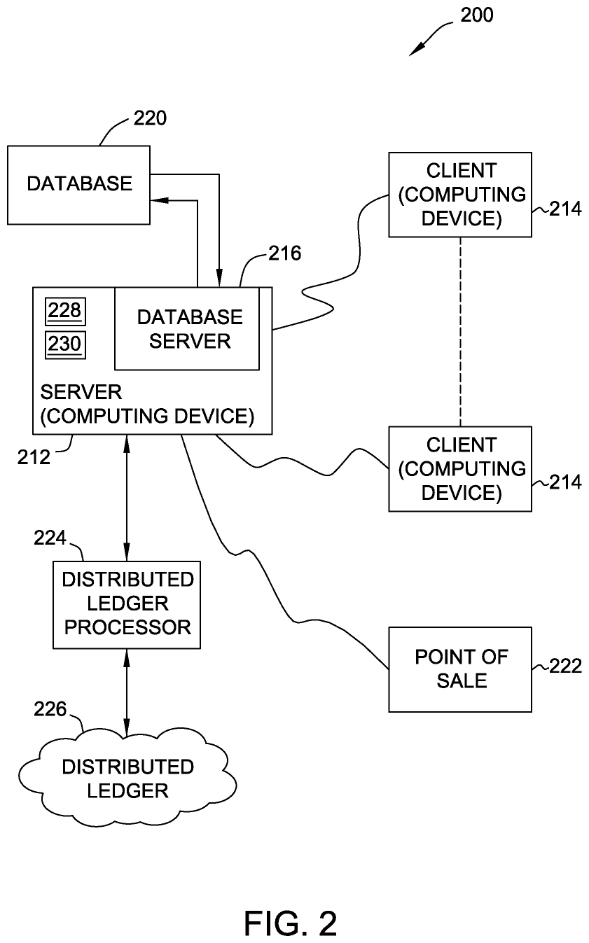

When a request for authorization is accepted, the available credit line of account 132 of cardholder 122 is decreased. Normally, a charge for a payment card transaction is not posted immediately to cardholder's 122 account 132 because bankcard associations, such as Mastercard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant bank 126, issuer bank 130, and an account merchant 124 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

Payment network 120 may further include a token generator 134 and a blockchain ledger 136. Token generator 134 may be in communication with network 128, and may generate a token after or during a purchase is made using payment network 120 based on transaction data flowing through network 128. As described above, in some embodiments, token generator 134 may determine whether an item is recyclable or re-sellable, or if the payment transaction relates to a re-selling of the item, and if so, generate the token corresponding with the item. As described herein, the token may include uniquely identifiable information as well as information relating to the owner of the item, the value of the item, and other information relating to the item. Token generator 134 may store and/or record the generated tokens in blockchain ledger 136. In some embodiments, token generator 134 may utilize data from network 128 to reevaluate, revalue, or update the item values associated with tokens recorded in blockchain ledger 136. If the item associated with a token recorded in blockchain ledger is resold via a payment transaction over payment network 120, token generator 134 may record the transfer in blockchain ledger 136. For example, the new owner of the item and/or an updated value associated with the item may be recorded in blockchain ledger 136.

FIG. 2 is a simplified block diagram of an example system 200 used for recording and tracking tokens corresponding to items using a distributed ledger, in accordance with one embodiment of the present disclosure. System 200 may be implemented in the performance of payment-by-card transactions received as part of processing cardholder transactions. In an exemplary embodiment, system 200 is a payment processing system that is configured to communicate with and share information to a distributed ledger.

In the exemplary embodiment, system 200 includes a server system 212 and client systems 214. In some embodiments, server system 212 may include and/or be configured to communicate with token generator 134 shown in FIG. 1, and may execute at least some of the functions described with respect to token generator 134. In some embodiments, client systems 214 include computers configured to implement a web browser or a software application, which enables client systems 214 to access server system 212 using the Internet. Client systems 214 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Alternatively, client systems 214 include any device capable of accessing the Internet including, but not limited to, a desktop computer, a laptop computer, a personal digital assistant (PDA), a cellular phone, a smartphone, a tablet, a phablet, or other web-based connectable equipment.

In an embodiment, server system 212 includes a database server 216 that is communicatively coupled to a database 220 for storing data. In an exemplary embodiment, database 220 stores transaction information from a plurality of cardholders and paths based on the individual transactions. According to the exemplary embodiment, database 220 is disposed remotely from server system 212. In other embodiments, database 220 is decentralized, or may a portion of server system 212. In the exemplary embodiment, a user (not shown) is able to access database 220 through client systems 214 by logging onto server system 212.

System 200 further includes one or more POS systems 222 that are communicatively coupled with the server system 212. POS systems 222 may be, for example, merchants 124 as shown in FIG. 1, and are communicatively coupled with server system 212 through payment network 120. POS system 222 may include, without limitation, machines that accept card swipes, online payment portals, or stored payment card numbers for recurring transactions.

In an exemplary embodiment, server system 212 is associated with a financial transaction interchange network, such as network 128 shown in FIG. 1, and is also referred to as an interchange computer system. In some embodiments, server system 212 is used for processing transaction data and analyzing for fraudulent transactions. In one embodiment, at least one of client systems 214 includes a computer system associated with an issuer of a transaction payment card. Accordingly, server system 212 and client systems 214 may be utilized to process transaction data relating to purchases a cardholder makes utilizing a transaction card processed by the interchange network and issued by the associated issuer. In the exemplary embodiment, at least one client system 214 may be associated with a user or a cardholder seeking to register, access information, or process a transaction with at least one of the interchange network, the issuer, or the merchant. In addition, client systems 214 or POS systems 222 may include individual POS devices (not shown) associated with a merchant and used for processing payment transactions. In an alternative embodiment, at least one client system 214 is utilized for investigating potential breaches.

In some embodiments, a distributed ledger processor 224 is communicatively coupled with server system 212. In some embodiments, distributed ledger processor 224 may include and/or be configured to communicate with token generator 134 shown in FIG. 1, and may execute at least some of the functions described with respect to token generator 134. Distributed ledger processor 224 can access server system 212 to store and access data and to communicate with the client systems 214 through server system 212. In some embodiments, distributed ledger processor 224 may be associated with, or is part of the payment system operating as its own node, or in communication with the payment network 120, shown in FIG. 1. In other embodiments, distributed ledger processor 224 is a separate node and is in electronic communication with the payment network 120. In some embodiments, distributed ledger processor 224 may be associated with, or be part of merchant bank 126, interchange network 128, and issuer bank 130, all shown in FIG. 1.

In an exemplary embodiment, server system 212 may capture transaction data from a transaction message. The transaction data may identify (i) a user, (ii) at least one item, and (iii) at least one transaction value. For example, the transaction message may be a payment card transaction request message submitted over a payment interchange network (e.g., ISO 8583 or ISO 20022 messages) at POS system 222, which may include an account number that identifies a user (e.g., an accountholder) and an amount associated with the purchase transaction. The transaction message may further include information capable of identifying one or more items involved in the transaction, such as a stock keeping unit (SKU) identifier, serial number, product name or description, or other information that may be used to identify the at least one item. By identifying the at least one item, server system 212 may determine if the at least one item is capable of being resold and/or recycled, and if so, track the item as described in further detail below. In some embodiments, additional data, such as a merchant associated with the transaction, a location of the transaction, or other such information may be captured from the transaction message and retained by the computer system.

As discussed herein, the transaction messages may include authorization messages and/or clearing messages that may be in an ISO 8583 or ISO 20022 message format for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In the exemplary embodiment, server system 212 may determine that the at least one item is a re-sellable item and/or a recyclable item based on one or more predefined rules. For example, server system 212 may, using a rules engine 228, compare and/or cross-references the at least one item with a list or database of items deemed to be re-sellable and/or recyclable. In some embodiments, server system 212 may use a machine learning and/or AI model 230 to determine whether an item is re-sellable or recyclable. The machine learning and/or artificial intelligence model may be trained using training data that includes exemplary items and labels indicating whether the exemplary items are re-sellable and/or recyclable. The machine learning model and/or artificial intelligence model, once trained, may be capable of predicting whether an input item is re-sellable and/or recyclable based on characteristics of the input item. Alternatively, other supervised or unsupervised machine learning techniques may be used to train such a model. In some embodiments, additional factors, such as whether the item is deemed to include potentially hazardous materials, a location of the item and local laws or regulations relating to the item, or other such factors may be used to determine whether an item can be resold or recycled. In addition, after the model is trained, the model can later be re-trained using actual input data that is used by the model to generate an output regarding whether the item at issue is re-sellable and/or recyclable, along with whether the item is actually later re-sold or at least acknowledged by the purchaser as being an item that is capable of being re-sold or recycled.

In some embodiments, server system 212 may include a dedicated module, such as rules engine 228 and/or AI model 230, configured to determine, when a purchase is made, whether the purchased item is recyclable and/or re-sellable. Based on whether the item is recyclable and/or re-sellable, a different type of token may be generated by server system 212 (e.g., using token generator 134), such that the token may indicate whether the purchased item is re-sellable and/or recyclable. For example, if the item is re-sellable, the token may be generated according to a first format that indicates the item is re-sellable, and if the item is recyclable, the token may be generated according to a second format (different from the first format) that enables the item to be tracked through the recycling process. In some embodiments, if server system is not capable of determining whether an item is recyclable and/or re-sellable with a sufficient confidence, it may prompt and/or message the purchasing user (e.g., at the user device via the user interface) to input whether the item is recyclable and/or re-sellable, if known.

Examples of items that are considered re-sellable or recyclable may include, among others, durable goods, appliances, vehicles, building materials, furniture, electronics, office equipment, clothing, artwork and jewelry, media such as books, music, films, and/or games, containers and/or bottles, and/or items made from recyclable materials such as metal or plastic. Items that are not considered re-sellable or recyclable may include, among others, food, beverages, soap, chemical products, and/or other items that are unable to be reused after some amount of use.

In the exemplary embodiment, in response to determining that the at least one item is a re-sellable item, server system 212 may automatically generate a token associated with the at least one item. The token may be a predefined data structure that may include at least one unique data element to distinguish the token from other tokens. The token may further include (i) a user identifier associated with the user and capable of identifying the user, (ii) an item identifier associated with the at least one item; and (iii) an item value associated with the at least one item. The item identifier may be unique to a specific item and/or class of similar items. The item identifier may be, for example, an SKU identifier, a serial number, and/or an alphanumeric code that has a predefined association with the item, where it was manufactured, when it was manufactured, and where and when it was sold. The item value may be determined based on the transaction data (e.g., the item value may be price and/or transaction amount associated with the transaction) and/or may be determined based on additional data. For example, in some embodiments, one or more third party databases may be queried by server system 212 to determine an item value, or machine learning and/or artificial intelligence techniques may be used to determine the item value.

In the exemplary embodiment, server system 212 may (e.g., using distributed ledger processor 224) record, store, and/or track the generated token in distributed ledger 226 (sometimes referred to herein as a “blockchain”). IN some embodiments, distributed ledger 226 may be similar to or the same as blockchain ledger 136 (shown in FIG. 1). For example, a new node of distributed ledger 226 may be generated, which may include the token and/or information referring to the token. The token and/or node may include a hashed identifier, which may be signed by the key of one or more participants of the transaction. In one example, SHA-256 hashing is utilized, which may additionally include Elliptic Curve Digital Signature Algorithm (ECDSA), where appropriate. In the exemplary embodiment, the computer system is configured to securely store assigned GUIDS and Key relationships in the back-end.

These security features associated with blockchain ledgers enable the token and information included in the token to be verified by other users, such as those potentially interested in purchasing the item through resale. Accordingly, aspects of the item, such as the item value, the manufacturer or brand (e.g., to ensure the item is not counterfeit), physical characteristics of the item (e.g., to ensure the item matches a description provided by the seller, an age of the item, previous owners of the item, a current or previous location of the item, and/or other such information. For example, if a token corresponds to a piece of jewelry, the token and/or associated blockchain records may include a brand, an original sale or any previous resale values, and physical characteristics of the jewelry such as a material, carat value, or the like. In another example, the token may correspond to an item to be recycled, such as copper plumbing, and a recycling entity may use previous transaction history included in the records to ensure that the copper plumbing was obtained legitimately. Because this information is automatically generated in response to a payment transaction and not readily modifiable, the token is, in itself, capable of verifying ownership and a value of an item.

In the exemplary embodiment, in response to receiving a request from a user device (e.g., one of client systems 214) associated with the user, server system 212 may parse distributed ledger 226 to identify tokens including the user identifier. For example, the user may desire to view which items the user currently owns that may be resold and/or recycled, and/or may wish to determine whether a specific item is re-sellable and/or recyclable, and may input the request via the user device via a user interface (e.g., displayed by a web page or other application executing on the user device).

In the exemplary embodiment, server system 212 may generate user interface data configured to cause the user device to display the user interface. The user interface may include data extracted from the identified tokens, such as the items associated with the identified tokens and the item values associated with the items. Accordingly, the user interface may enable the user to view each of the user's currently-owned re-sellable and/or recyclable items and their corresponding values. In some embodiments, the user interface may present the items as a list, with the list including each item and its corresponding value. In some embodiments, the list may be searchable and/or filterable. For example, the user may input a keyword search terms, based on which items matching the search terms may be displayed. In another example, the user interface may enable the list to be filtered based on certain parameters, such as item type, item value, date purchased, and/or other such factors. In some embodiments, the user interface may include chatbot functionality. For example, a user may input a natural language query (e.g., text or speech), and the computer system may utilize one or more chatbots to generate search results within the user interface.

In some embodiments, server system 212 may receive an update message from the user device. The update message may include an updated item value associated with at least one item. For example, the user may desire to update the value of the item so that the user may resell the item at an appropriate value. The user may input a new value (e.g., a desired resale price) via the user interface, and in response, the user device may generate the update message and transmit the update message to server system 212. In response to receiving the update message, computer system may modify the token or generate another token relating to the item. The modified or new token may include the updated item value, as well as the current user identifier and item identifier associated with the item. The modification to the token or the new token may be recorded in distributed ledger 226 (e.g., using distributed ledger processor 224), so that subsequent searches and retrievals based the item identifier associated with the specified item will cause the updated item value to be presented. The user may update an item value multiple times in this manner. In some embodiments, the item value may be periodically updated automatically, for example, based on third party information (e.g., retrieved from the Internet and/or third party databases). For example, if the item includes a commodity such as wood, and a price of wood increases, the computer system may automatically calculate an updated item value and generate a new token to update the item value associated with the item in the blockchain.

In some embodiments, server system 212 may receive a resale request message from the user device, which enables the user to list an item for sale in a virtual marketplace. For example, the user may input via the user interface that the user desires to resell a certain item. In some embodiments, this user input may include a “drag and drop” operation, in which the user touches or clicks on the item and drags the item to a “marketplace” portion of the user interface. The resale request message may include the item identifier associated with the item that the user desires to resell. In response to receiving the resale request message, the information stored in the blockchain for the item may become publicly viewable such that the blockchain enables discovery of the token in the blockchain by at least one other computing device (referred to as a “buyer computing device.” which may be one of client computing devices 214). In other words, if other users of the system may search the blockchain the listed item may be retrieved and displayed on a respective user interface (referred to as a “buyer interface”) of the buyer computing device, along with other information such as the item value currently associated with the item and/or information relating to the user who currently owns the item (e.g., a user name, location, etc.). In some embodiments, the value of the item may be automatically updated by server system 212 when the system crawls the Internet to search for similar items and the prices of those items in order to determine the current value of the item. Server system 212 (e.g., using distributed ledger processor 224) then updates the value of the item in the blockchain so that the value of the item is always up-to-date. In some embodiments, the buyer interface displayed by the buyer computing device may enable searching for items and displaying search results. For example, the potential buyer may input a keyword search terms, based on which items matching the search terms may be displayed. The buyer interface may enable the list to be filtered based on certain parameters, such as item type, item value, date purchased, and/or other such factors. In some embodiments, the buyer interface may include chatbot functionality. For example, a user may input a natural language query (e.g., text or speech), and server system 212 may utilize one or more chatbots to generate search results within the user interface.

In some embodiments, server system 212 may receive a purchase request message from the buyer computing device associated with the buyer. For example, the purchase request message may be generated and transmitted by the buyer computing device in response to input from the buyer indicating that the buyer wishes to purchase the item. In some embodiments, the buyer must submit payment information via the buyer interface, such payment card information, in order to request to purchase the item. In response to receiving the purchase request message, server system 212 may modify the token to include, or generate a new token including, a second user identifier associated with the buyer. The modified or new token may also include the item identifier and current item value associated with the at least one item. The modification or new token may be recorded in distributed ledger 226 (e.g., using distributed ledger processor 224), such that the item will now be associated with the buyer upon subsequent searching and/or parsing of the blockchain. In some embodiments, server system 212 may track sales and/or transfers of ownership of the item that occur outside of the virtual marketplace, such as based on transaction data as described above.

In some embodiments, the item may include a tag, which may enable the item to be tracked through transfers of possession and/or ownership that occur outside the marketplace provided by the computer system. For example, a user may deposit an item to be recycled, and possession of the item may be taken over by a recycling entity. The tag may include a visible indicator such as an alphanumeric code, a quick response (QR) code, or a bar code, or another type of tag such as a radio frequency (RF) near field communication (NFC) tag, which may be scanned and/or input by the entity receiving the item. The tag may include the item identifier, enabling the item to be identified, and in some embodiments, associated with the previous owner of the item. In response to scanning and/or receiving input of the tag, a third party computing device (e.g., one of client computing systems 214 may generate and transmit a tag message including the item identifier and/or any other information included in the tag. Server system 212 may receive the tag message from a third party computing device, and cause the user computing device to display a notification that the at least one item has been received by the third party. The computer system may further generate a new token and/or otherwise update distributed ledger 226 (e.g., using distributed ledger processor 224) to indicate that the item is now owned by a new entity.

In embodiments in which the item is recycled, the user may view the notifications indicating that the item has been received by a recycling entity and/or recycled. In some embodiments, server system 212 may compile statistics for the user, such as a total amount of items recycled and/or a total value recycled, which may be viewed via the user interface. In some embodiments, server system 212 may retrieve information about what new products materials from the recycled items were used to make, and cause this information to be displayed via the user interface. Receiving notifications and/or being able to track what happens to recycled items may incentivize the user to recycle more often. In some embodiments, the computer system may determine, based information about what the user has recycled, that the user is eligible for a reward, such as a cash reward and/or a coupon, which may incentivize the user to recycle. In addition, ability to track recycled items for a plurality of people in a predefined geographic location allows server system 212 to track how a neighborhood, a community, a town and/or a city is doing with its recycling efforts. In fact, server system 212 can determine when items are being recycled and by who, and using GPS technology can determine where those items are being recycled, and thus, can generate a dashboard for display on a user device to see how many items are being recycled and/or how much of a positive impact certain recycling efforts are having on the environment.

In some cases, items may be destroyed, and/or may be merged or divided to create new items. In such cases, tokens corresponding to the items may be modified or supplanted in distributed ledger 226 to indicate that the item associated with the token no longer exists, and new tokens may be generated and stored in distributed ledger 226 representing the new items created by merging or dividing previous items.

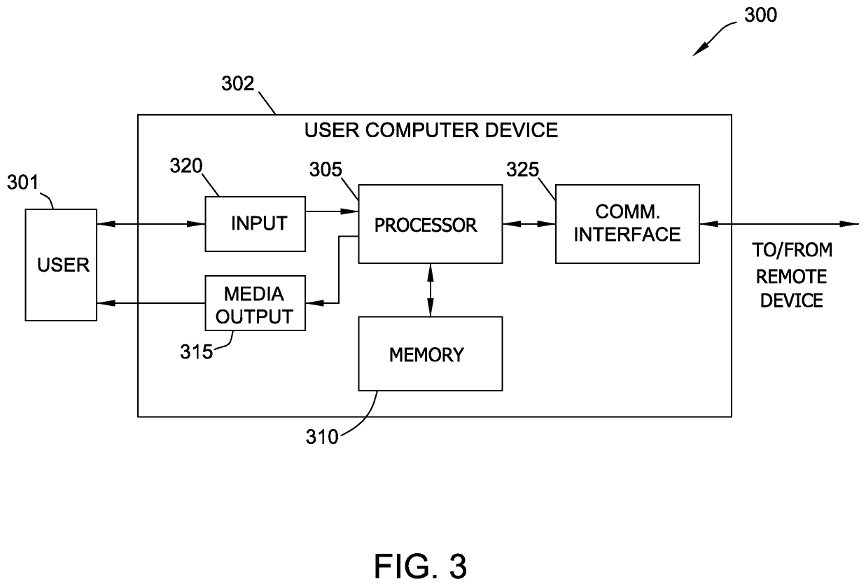

FIG. 3 illustrates an exemplary configuration of a client system 300 in accordance with an embodiment of the present disclosure. In the exemplary embodiment, client system 300 includes at least one user computer device 302, operated by a user 301. User computer device 302 may include, but is not limited to, one or more of client systems 214 and distributed ledger processor 224 (both shown in FIG. 2). User computer device 302 includes a processor 305 for executing instructions, and a memory area 310. In some embodiments, executable instructions are stored in memory area 310. Processor 305 may, for example, include one or more processing units (e.g., in a multi-core configuration). Memory area 310 may, for example, the any device allowing information such as executable instructions and/or transaction data to be stored and retrieved. Memory area 310 may further include one or more computer readable media.

In an exemplary embodiment, user computer device 302 further includes at least one media output component 315 for presenting information to user 301. Media output component 315 may, for example, be any component capable of converting and conveying electronic information to user 301. In some embodiments, media output component 315 includes an output adapter (not shown), such as a video adapter and/or an audio adapter, which is operatively coupled to processor 305 and operatively coupleable to an output device (also not shown), such as a display device (e.g., a cathode ray tube (CRT), liquid crystal display (LCD), light emitting diode (LED) display, or “electronic ink” display) or an audio output device (e.g., a speaker or headphones).

In some embodiments, media output component 315 is configured to include and present a graphical user interface (not shown), such as a web browser and/or a client application, to user 301. The graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

In an embodiment, user computer device 302 further includes a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

In an exemplary embodiment, memory area 310 stores computer readable instructions for providing a user interface to user 301 through media output component 315 and, optionally, for receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

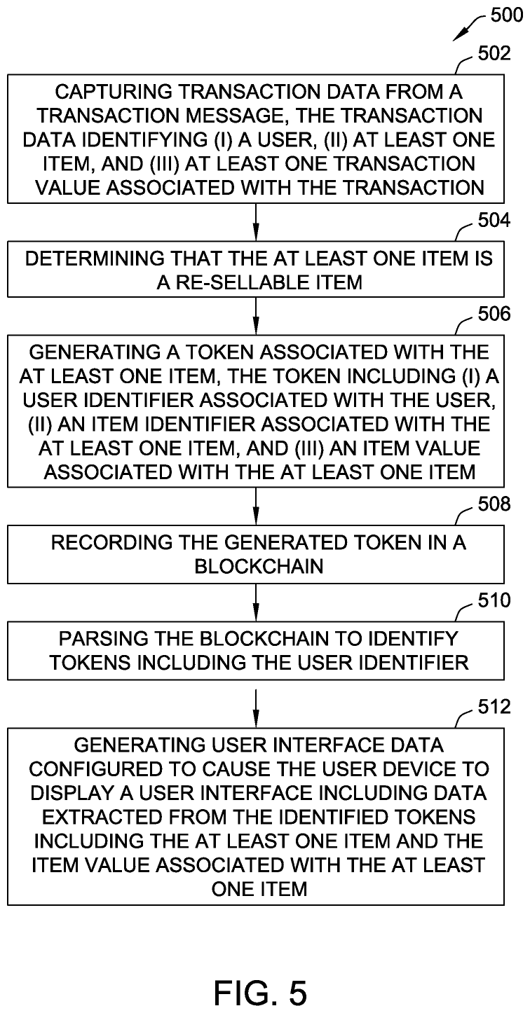

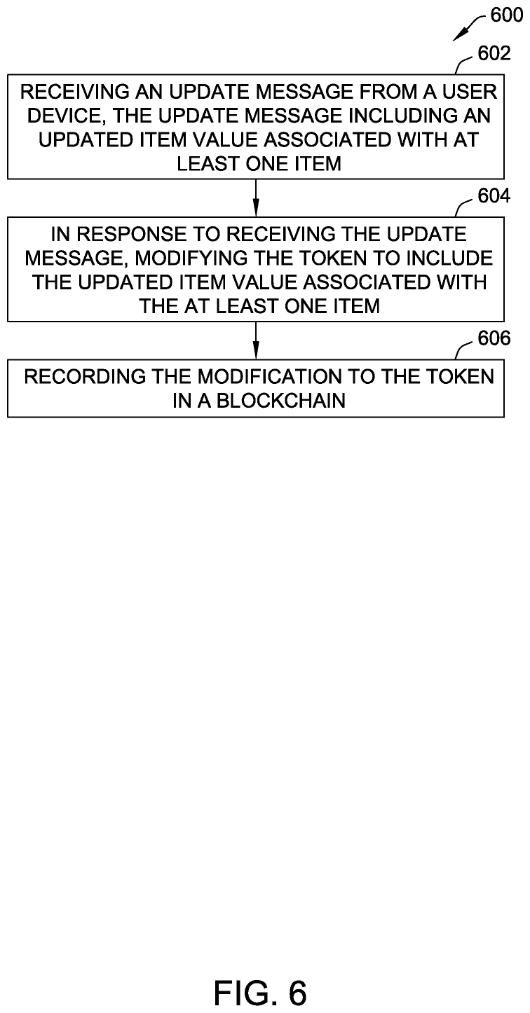

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 may be programmed with instructions such that it may execute the processes as illustrated in FIGS. 5 and 6, below.

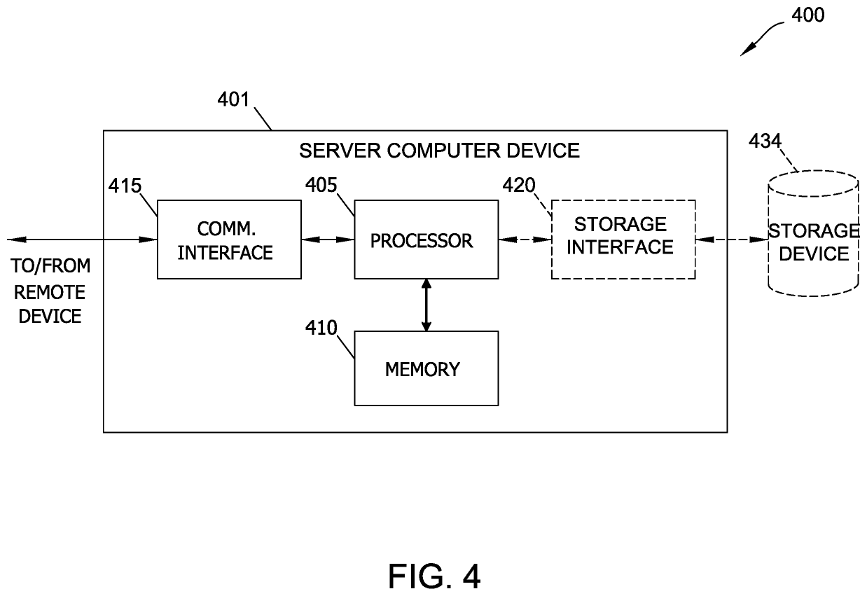

FIG. 4 illustrates an exemplary configuration of a server system 400, in accordance with an embodiment of the present disclosure. In the exemplary embodiment, server system 400 includes at least one server computer device 401, in electronic communication with at least one storage device 434. Server computer device 401 may include, but is not limited to, one or more of server system 212 and database server 216 (shown in FIG. 2). In the exemplary embodiment, server computer device 401 includes a processor 405 for executing instructions (not shown) stored in a memory 410. In an embodiment, processor 405 may include one or more processing units (e.g., in a multi-core configuration). The instructions may be executed within various different operating systems on the server computing device 401, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

In the exemplary embodiment, processor 405 is operatively coupled to a communication interface 415 such that system 400 is capable of communicating with a remote device such as a user system or another system 400. For example, communication interface 415 may receive requests from client system 300 (FIG. 3) via the Internet, within the scope of the embodiment illustrated in FIG. 4.

In the exemplary embodiment, processor 405 is also operatively coupled to a storage device 434, which may be, for example, a computer-operated hardware unit suitable for storing and/or retrieving data. In some embodiments, storage device 434 is integrated in system 400. For example, system 400 may include one or more hard disk drives as storage device 434. In other embodiments, storage device 434 is external to system 400 and may be accessed by a plurality of systems 400. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 405 is operatively coupled to storage device 434 via an optional storage interface 420. Storage interface 420 may include, for example, a component capable of providing processor 405 with access to storage device 434. In an exemplary embodiment, storage interface 420 further includes one or more of an Advanced Technology Attachment (ATA) adapter, a Serial ATA (SATA) adapter, a Small Computer System Interface (SCSI) adapter, a RAID controller, a SAN adapter, a network adapter, and/or a similarly capable component providing processor 405 with access to storage device 434.

Memory area 410 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

FIG. 5 is a flow diagram illustrating an exemplary method 500 for tracking items. In an exemplary embodiment, method 500 may be performed by system 200 (shown in FIG. 2).

In the exemplary embodiment, method 500 may include capturing 502 transaction data from a transaction message (e.g., an ISO 8583 or ISO 20022 message). The transaction data may include data for identifying (i) a user, (ii) at least one item, and (iii) at least one transaction value associated with the transaction. In some embodiments, capturing 502 the transaction data may be performed by server system 212 (shown in FIG. 2).

In the exemplary embodiment, method 500 may further include determining 504 that the at least one item is a re-sellable item. In some embodiments, determining 504 that the at least one item is a re-sellable item may be performed by server system 212 (shown in FIG. 2).

In the exemplary embodiment, method 500 may further include, in response to determining that the at least one item is a re-sellable item, generating 506 a token associated with the at least one item. The token may include (i) a user identifier associated with the user, (ii) an item identifier associated with the at least one item, and (iii) an item value associated with the at least one item. Alternatively, if a token already exists for the at least one item, the existing token may be modified to include the user identifier associated with the user. In some embodiments, generating 506 the token may be performed by server system 212 and/or distributed ledger processor 224 (shown in FIG. 2).

In the exemplary embodiment, method 500 may further include recording 508 the generated token in a blockchain (e.g., distributed ledger 226, shown in FIG. 2). In some embodiments, recording 508 the token may be performed by server system 212 and/or distributed ledger processor 224 (shown in FIG. 2).

In the exemplary embodiment, method 500 may further include, in response to receiving a request from a user device associated with the user, parsing 510 the blockchain to identify tokens including the user identifier. The identified tokens may include the generated token. In some embodiments, parsing 510 the blockchain may be performed by server system 212 and/or distributed ledger processor 224 (shown in FIG. 2).

In the exemplary embodiment, method 500 may further include generating 512 user interface data configured to cause the user device to display a user interface. The user interface may include data extracted from the identified tokens including the at least one item and the item value associated with the at least one item. In some embodiments, the user interface includes a list of items associated with the user identifier. In some such embodiments, the list further includes a respective item value associated with each of the items associated with the user identifier. In some embodiments, generating 512 the user interface data may be performed by server system 212 (shown in FIG. 2).

FIG. 6 is a flow diagram illustrating an exemplary method 600 for updating an item value. In an exemplary embodiment, method 600 may be performed by system 200 (shown in FIG. 2).

In the exemplary embodiment, method 600 may include receiving 602 an update message from a user device. The update message may include an updated item value associated with at least one item. In some embodiments, receiving 602 the update message may be performed by server system 212 (shown in FIG. 2).

In the exemplary embodiment, method 600 may further include, in response to receiving the update message, modifying 604 the token to include the updated item value associated with the at least one item. In some embodiments, modifying 604 the token may be performed by server system 212 and/or distributed ledger processor 224 (shown in FIG. 2).

In the exemplary embodiment, method 600 may further include recording 606 the modification to the token in a blockchain (e.g., distributed ledger 226, shown in FIG. 2). In some embodiments, recording 606 the modification may be performed by server system 212 and/or distributed ledger processor 224 (shown in FIG. 2).

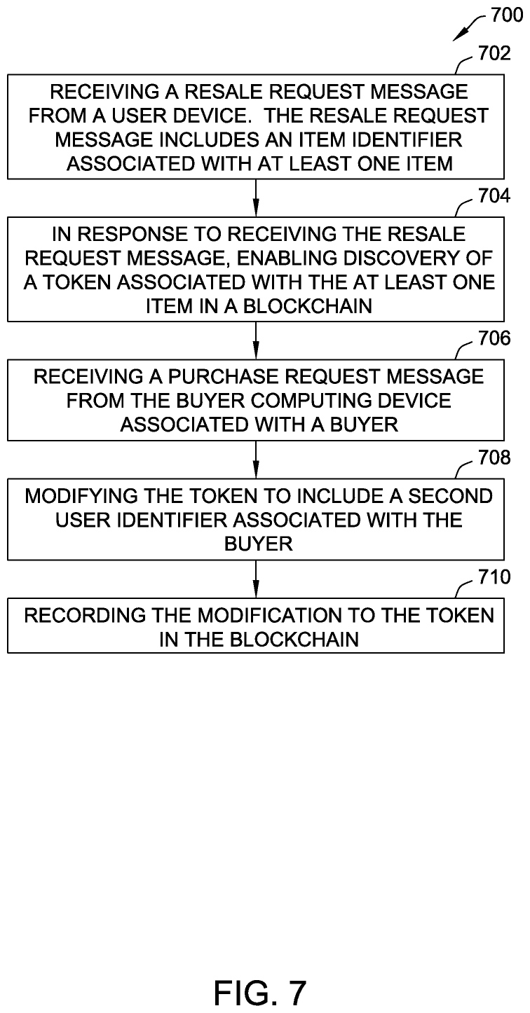

FIG. 7 is a flow diagram illustrating an exemplary method 700 for using a token to track a transfer of an item via a virtual marketplace. In an exemplary embodiment, method 700 may be performed by system 200 (shown in FIG. 2).

In the exemplary embodiment, method 700 may include receiving 702 a resale request message from a user device. The resale request message includes an item identifier associated with at least one item. In some embodiments, receiving 702 the resale request message may be performed by server system 212 (shown in FIG. 2).

In the exemplary embodiment, method 700 may further include, in response to receiving the resale request message, enabling 704 discovery of a token associated with the at least one item in a blockchain (e.g., distributed ledger 226) by at least one buyer computing device. In some embodiments, enabling 704 discovery of the token may be performed by server system 212 and/or distributed ledger processor 224 (shown in FIG. 2).

In the exemplary embodiment, method 700 may further include receiving 706 a purchase request message from the buyer computing device associated with a buyer. In some embodiments, receiving 706 the purchase request message may be performed by server system 212 (shown in FIG. 2).

In the exemplary embodiment, method 700 may further include, in response to receiving the purchase request message, modifying 708 the token to include a second user identifier associated with the buyer. In some embodiments, modifying 708 the token may be performed by server system 212 and/or distributed ledger processor 224 (shown in FIG. 2).

In some embodiments, method 700 may further include recording 710 the modification to the token in the blockchain. In some embodiments, recording 710 the modification may be performed by server system 212 and/or distributed ledger processor 224 (shown in FIG. 2).

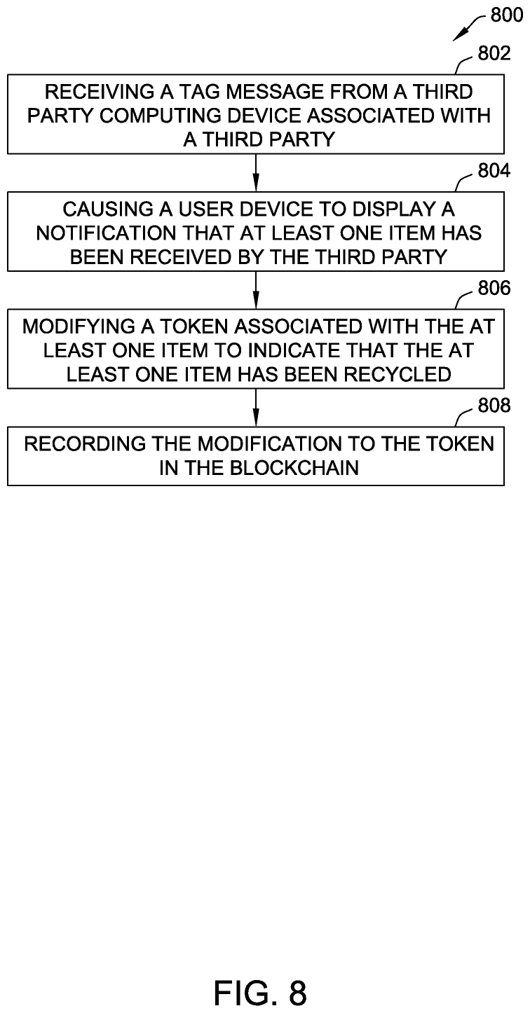

FIG. 8 is a flow diagram illustrating an exemplary method 800 for tracking an item transferred to a third party such as a recycling entity (e.g., that will recycle the item). In an exemplary embodiment, method 800 may be performed by system 200 (shown in FIG. 2). In the exemplary embodiment, the item may include a tag that includes a tag identifier. In some embodiments, the tag is at least one of an alphanumeric code, a quick response (QR) code, and/or a bar code.

In the exemplary embodiment, method 800 may include receiving 802 a tag message from a third party computing device associated with the third party. The tag message may be generated in response to a detection of the tag by the third party computing device, and the tag message may include the tag identifier and/or the item identifier. In some embodiments, receiving 802 the tag message may be performed by server system 212 (shown in FIG. 2).

In the exemplary embodiment, method 800 may further include causing 804 a user device to display a notification that the at least one item has been received by the third party. In embodiments in which the third party is a recycling entity, the notification includes an indication that the at least one item is being recycled. The user device may also display additional information and/or statistics relating to the user's recycling activity, as described herein. In some embodiments, causing 804 the user device to display the notification may be performed by server system 212 (shown in FIG. 2).

In some embodiments, method 800 may further include, in response to receiving the purchase request message, modifying 806 the token associated with the at least one item to indicate that the at least one item has been recycled. In some embodiments, modifying 806 the token may be performed by server system 212 and/or distributed ledger processor 224 (shown in FIG. 2).

In some embodiments, method 800 may further include recording 808 the modification to the token in the blockchain. In some embodiments, recording 808 the modification may be performed by server system 212 and/or distributed ledger processor 224 (shown in FIG. 2).

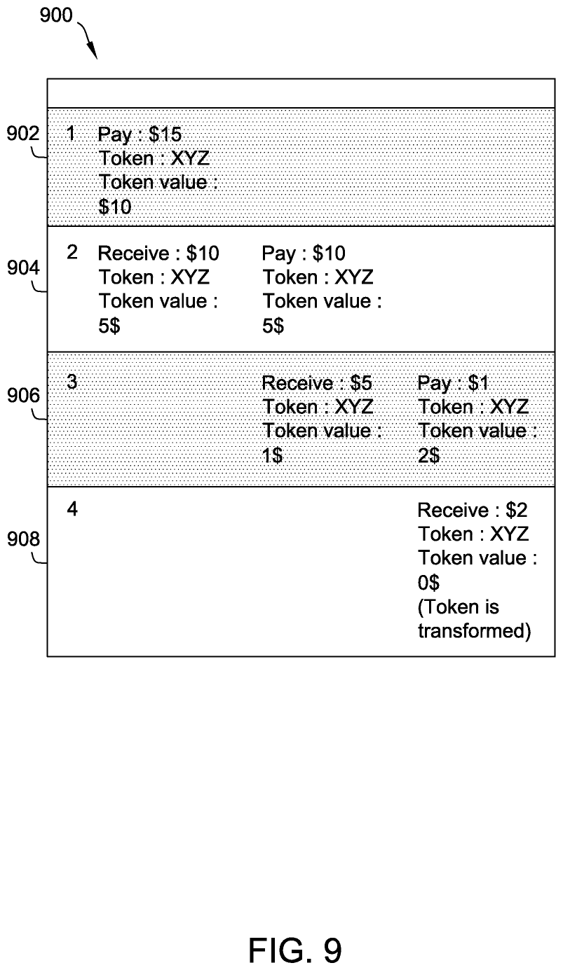

FIG. 9 is a chart 900 illustrating an exemplary sequence of modifications of a token associated with an item. At a first step 902, the token is generated. The token may be generated in response to receiving transaction data, as described above. The generated token may include an identifier (XYZ) and a token or item value (shown as $10 at first step 902). The identifier remains fixed, but the item or token value may change, as shown in second step 904, third step 906, and fourth step 908. Second step 904 and third step 906 represent transfers of the token between entities. For example, second step 904 may represent a transfer from one use to another, for example, using the virtual marketplace, and third step 906 may represent a transfer from a user to a recycling entity. Fourth step 908 represents a transformation of the token. For example, if the item associated with the token is recycled and no longer exists, the token may be modified to indicate that the item associated with the token no longer exists. In some embodiments, new items created using materials from the recycled item may be linked in the system to the token associated with the previous item, so that a user who recycled the item may determine how the recycled item was used after being disposed by the user.

Through the advantageous embodiments described herein, the present systems and methods enable individuals to easily track what re-sellable and/or recyclable items are owned by the user. This may be accomplished by generating tokens that represent the items in real time based on transaction data, determining whether the tokens correspond to a re-sellable or recyclable items based on one or more predefined rules, and recording the tokens in a distributed ledger such as a blockchain. The blockchain is an inherently secure way of storing the token, because nodes of the blockchain, in which the token may be recorded, are difficult or impossible to modify once generated in the blockchain structure.

For example, the system may capture data from an ISO compliant message transmitted over a transaction network such as payment network 120. As the item is being purchased, the system may automatically determine, in real time without any additional user input, whether the item is recyclable and/or re-sellable, and may then automatically generate a token in response. The token may have security features build into the token that prevent the token from being altered or reproduced outside the protocols of the system. The automatically-generated token may include information such as where the item was purchased, who purchased the item, the payment value associated with the purchase, where the purchase occurred, and other such information. This information may be incorporated into the secure token and recorded in the distributed ledger, enabling this information, such as who currently owns the product, the current value associated with the product, and information relating to characteristics of the item to be verified by others (e.g., others who may potentially purchase the items in a resale). By utilizing real time transaction data, the system enables these secure records to be generated in the ledger in real time at the moment of purchase.

Additionally, the tokens and associated records may further include a value associated with the item, so that users may easily and securely track the value. The system may further enable users to transfer the token and corresponding item to another user, with the secure records of the token and value of the item stored in the blockchain serving to validate the transfer.

Additional, physical tags may be used for tracking the items. For example, an entity such as a recycling entity receiving an item may scan or other wise enter data associated with the physical tag, and the system may automatically update the token and its corresponding record in the blockchain to indicate that the item has been transferred to the new entity. In this way, the secure records may be maintained even if the transfer is not accompanied by a payment card transaction or recorded transaction within the virtual marketplace.

As will be appreciated based on the foregoing specification, the above-described embodiments of the disclosure may be implemented using computer programming or engineering techniques including computer software, firmware, hardware or any combination or subset thereof, wherein the technical effect is providing positioning determination using wireless and payment transactions data. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer system including at least one processor in communication with at least one memory, the at least one processor configured to:
capture transaction data from a transaction message, the transaction data identifying (i) a user, (ii) at least one item, and (iii) at least one transaction value;
determine that the at least one item is a re-sellable item;
in response to determining that the at least one item is a re-sellable item, generate a token associated with the at least one item, the token including (i) a user identifier associated with the user, (ii) an item identifier associated with the at least one item, and (iii) an item value associated with the at least one item;
record the generated token in a blockchain;
in response to receiving a request from a user device associated with the user, parse the blockchain to identify tokens including the user identifier, the identified tokens including the generated token; and
generate user interface data configured to cause the user device to display a user interface, wherein the user interface includes data extracted from the identified tokens including the at least one item and the item value associated with the at least one item.

2. The computer system of claim 1, wherein the at least one processor is further configured to:
receive an update message from the user device, the update message including an updated item value associated with the at least one item;
in response to receiving the update message, modify the token to include the updated item value associated with the at least one item; and
record the modification to the token in the blockchain.

3. The computer system of claim 1, wherein the at least one processor is further configured to:
receive a resale request message from the user device, the resale request message including the item identifier associated with the at least one item; and
in response to receiving the resale request message, enable discovery of the token in the blockchain by at least one buyer computing device.

4. The computer system of claim 3, wherein the at least one processor is further configured to:
receive a purchase request message from the buyer computing device associated with a buyer; and
in response to receiving the purchase request message, modify the token to include a second user identifier associated with the buyer; and
record the modification to the token in the blockchain.

5. The computer system of claim 3, wherein the resale request message is generated by the user device in response to a drag and drop input to the user interface.

6. The computer system of claim 1, wherein the user interface includes a list of items associated with the user identifier.

7. The computer system of claim 6, wherein the list includes a respective item value associated with each of the items associated with the user identifier.

8. The computer system of claim 1, wherein the at least one item includes a tag, the tag including the item identifier, and wherein the at least one processor is further configured to:
receive a tag message from a third party computing device associated with a third party, the tag message generated in response to a detection of the tag by the third party computing device, the tag message including the item identifier; and
cause the user device to display a notification that the at least one item has been received by the third party.

9. The computer system of claim 8, wherein the third party is a recycling entity, and wherein the notification includes an indication that the at least one item is being recycled.

10. The computer system of claim 8, wherein the tag is at least one of an alphanumeric code, a quick response (QR) code, and/or a bar code.

11. A computer-implemented method performed by a computer system including at least one processor in communication with at least one memory, the computer-implemented method comprising:
capturing transaction data from a transaction message, the transaction data identifying (i) a user, (ii) at least one item, and (iii) at least one transaction value;
determining that the at least one item is a re-sellable item;
in response to determining that the at least one item is a re-sellable item, generating a token associated with the at least one item, the token including (i) a user identifier associated with the user, (ii) an item identifier associated with the at least one item, and (iii) an item value associated with the at least one item;
recording the generated token in a blockchain;
in response to receiving a request from a user device associated with the user, parsing the blockchain to identify tokens including the user identifier, the identified tokens including the generated token; and
generating user interface data configured to cause the user device to display a user interface, wherein the user interface includes data extracted from the identified tokens including the at least one item and the item value associated with the at least one item.

12. The computer-implemented method of claim 11, further comprising:
receive an update message from the user device, the update message including an updated item value associated with the at least one item;
in response to receiving the update message, modify the token to include the updated item value associated with the at least one item; and
record the modification to the token in the blockchain.

13. The computer-implemented method of claim 11, further comprising
receive a resale request message from the user device, the resale request message including the item identifier associated with the at least one item; and
in response to receiving the resale request message, enable discovery of the token in the blockchain by at least one buyer computing device.

14. The computer-implemented method of claim 13, further comprising:
receive a purchase request message from the buyer computing device associated with a buyer; and
in response to receiving the purchase request message, modify the token to include a second user identifier associated with the buyer; and
record the modification to the token in the blockchain.

15. The computer-implemented method of claim 13, wherein the resale request message is generated by the user device in response to a drag and drop input to the user interface.

16. The computer-implemented method of claim 11, wherein the user interface includes a list of items associated with the user identifier.

17. The computer-implemented method of claim 16, wherein the list includes a respective item value associated with each of the items associated with the user identifier.

18. The computer-implemented method of claim 11, wherein the at least one item includes a tag, the tag including the item identifier, and wherein the computer-implemented method further comprises:
receive a tag message from a third party computing device associated with a third party, the tag message generated in response to a detection of the tag by the third party computing device, the tag message including the item identifier; and
cause the user device to display a notification that the at least one item has been received by the third party.

19. The computer-implemented method of claim 18, wherein the third party is a recycling entity, and wherein the notification includes an indication that the at least one item is being recycled.

20. At least one non-transitory computer-readable storage media having computer-executable instructions embodied thereon, wherein when executed by a computer system including at least one processor in communication with at least one memory, the computer-executable instructions cause at least one processor configured to:
capture transaction data from a transaction message, the transaction data identifying (i) a user, (ii) at least one item, and (iii) at least one transaction value;
determine that the at least one item is a re-sellable item;
in response to determining that the at least one item is a re-sellable item, generate a token associated with the at least one item, the token including (i) a user identifier associated with the user, (ii) an item identifier associated with the at least one item, and (iii) an item value associated with the at least one item;
record the generated token in a blockchain;
in response to receiving a request from a user device associated with the user, parse the blockchain to identify tokens including the user identifier, the identified tokens including the generated token; and
generate user interface data configured to cause the user device to display a user interface, wherein the user interface includes data extracted from the identified tokens including the at least one item and the item value associated with the at least one item.
